(19) United States
(12) Patent Application Publication
(10) Pub. No.: US 2024/0182355 A1
(43) Pub. Date: Jun. 6, 2024

(54) GLASS-CERAMIC AND COOKTOP USING SAME

(71) Applicant: SAMSUNG ELECTRONICS CO., LTD., Suwon-si (KR)

(72) Inventors: Jiyoung SONG, Suwon-si (KR); Hyungin KIM, Suwon-si (KR); Youngdeog KOH, Suwon-si (KR); Kwangjoo KIM, Suwon-si (KR)

(73) Assignee: SAMSUNG ELECTRONICS CO., LTD., Suwon-si (KR)

(21) Appl. No.: 18/388,044

(22) Filed: Nov. 8, 2023

Related U.S. Application Data
(63) Continuation of application No. PCT/KR23/15355, filed on Oct. 5, 2023.

(30) Foreign Application Priority Data
Dec. 2, 2022 (KR) 10-2022-0166774
Apr. 26, 2023 (KR) 10-2023-0055035

(51) Int. Cl. C03C 17/23; C03C 17/22; C03C 17/28; F24C 15/10

(52) U.S. Cl. CPC C03C 17/23; C03C 17/225; C03C 17/28; F24C 15/10

(57) ABSTRACT

Disclosed are a glass-ceramic having increased clarity of colors by controlling a microstructure and improved cleanability by a polishing process and a cooktop including same. The glass-ceramic according to an embodiment of the present disclosure includes: a glass material; and an uneven layer formed on the glass material, wherein hexahedral crystals may be included as a microstructure.

### CROSS-REFERENCE TO RELATED APPLICATIONS

This application is a Bypass Continuation Application of International Application No. PCT/KR2023/015355, filed on Oct. 5, 2023, which is based on and claims priority to Korean Patent Application No. 10-2022-0166774, filed on Dec. 2, 2022, and Korean Patent Application No. 10-2023-0055035, filed on Apr. 26, 2023, in the Korean Intellectual Property Office, the disclosure of which are incorporated by reference herein in their entireties.

### BACKGROUND ART

### 1. FIELD

The present disclosure relates to a glass-ceramic and a cooktop using the class-ceramic. More particularly, the disclosure relates to a glass-ceramic having increased clarity of colors by controlling a microstructure which improves cleanability by a polishing process, and a cooktop including the glass-ceramic.

### 2. Description of Related Art

Induction ranges (induction heating apparatuses) have been used as heat sources to generate heat. Particularly, cooktops (or hobs) have been used as cooking apparatuses for heating food using induction ranges.

In general, glass-ceramics with excellent heat resistance have been used on the top of cooktops. Glass-ceramics are rarely fractured by thermal shock and have excellent mechanical strength and thermal conductivity. However, glass-ceramics of cooktops, which are continuously exposed to high-temperature and contaminated environments, may require properties such as easier cleanability and a higher heat resistance. Thus, research has been conducted into forming an uneven layer to improve cleanability and using various coating layers to improve properties such as increasing the heat resistance.

### SUMMARY

To overcome the above-described problems, provided are a glass-ceramic including a heat-resistant and antifouling coating layer on a glass material and including an uneven layer having micro-dimples and a cooktop including the glass-ceramic.

In accordance with an aspect of the present disclosure, a glass-ceramic includes: a glass material including an uneven layer: a coating layer including an upper printed layer, that is disposed on the glass material: and a lower printed layer disposed under the glass material, wherein the uneven layer includes micro-dimples.

In addition, in the glass-ceramic according to an embodiment of the present disclosure, the glass material may include, in percentage by weight (wt %), 1 to 10% of Li₂O, 15 to 25% of Al₂O₃, and the remaining balance of wt % comprises SiO₂ and impurities.

In addition, in the glass-ceramic according to an embodiment of the present disclosure, the micro-dimples may have a width in a range from 50 μm to 150 μm and a depth in a range from 20 μm to 100 μm.

In addition, in the glass-ceramic according to an embodiment of the present disclosure, the upper printed layer may include a display layer.

In addition, in the glass-ceramic according to an embodiment of the present disclosure, the display layer may have a transmittance in a range from 80% to 90%.

In addition, in the glass-ceramic according to an embodiment of the present disclosure, the coating layer may include at least one compound selected from SiO₂, polysilazane (SIN), SiX, C₄F₉CH₃, C₆F₁₄, C₅H₃₀F₉, Zr, ZrO, and ZrO₂(where X is a halogen element).

In addition, in the glass-ceramic according to an embodiment of the present disclosure, the lower printed layer may further include a chroma color layer.

In addition, in the glass-ceramic according to an embodiment of the present disclosure, the lower printed layer may further include a heat-resistant shielding layer.

In addition, in the glass-ceramic according to an embodiment of the present disclosure, the coating layer may have a thickness in a range from 30 nm to 800 nm.

In addition, in the glass-ceramic according to an embodiment of the present disclosure, a surface roughness Ra may be in a range from 2.4 μm to 4.0 μm.

In addition, in the glass-ceramic according to an embodiment of the present disclosure, a color difference value L may be 25 or more.

In addition, in the glass-ceramic according to an embodiment of the present disclosure, the coating layer includes a contact angle that may be 100° or more after heating at 350° C. for 24 hours.

In addition, in the glass-ceramic according to an embodiment of the present disclosure, the coating layer includes a contact angle that may be 70° or more after heating at 350° C. for 72 hours.

In addition, in the glass-ceramic according to an embodiment of the present disclosure, a surface color difference ΔE before and after cleaning oil and Kimchi aging over 1200 hours may be 1.0 or less.

In addition, in the glass-ceramic according to an embodiment of the present disclosure, a vertical force causing scratches may be in a range from 15 N to 20 N.

In accordance with another aspect of the present disclosure, a method of manufacturing a glass-ceramic includes: preparing a glass-ceramic precursor S1: forming a glass-ceramic via crystallization by heating: forming the glass-ceramic S2, cooling the glass-ceramic S3: chemically strengthening the glass-ceramic S4: forming micro-dimples S5: polishing S6: printing a chroma color layer S7: printing a heat-resistant shielding layer S8; and coating the glass-ceramic S9.

In accordance with another aspect of the present disclosure, a cooktop includes: a cooktop main body: and a glass-ceramic provided on a top of the cooktop main body, wherein the glass-ceramic includes: a glass material including an uneven layer; a coating layer including an upper printed layer and disposed on the glass material: and a lower printed layer is disposed under the glass material, wherein the uneven layer includes micro-dimples.

According to an embodiment of the present disclosure, a glass-ceramic and a cooktop including same may be provided. The glass-ceramic may have improved heat resistance and antifouling property by forming a heat-resistant and antifouling coating layer on the glass material and may have improved cleanability by forming an uneven layer having micro-dimples.

However, the effects obtainable by the glass-ceramic and the cooktop including same according to the embodiments of the present disclosure are not limited to the aforementioned effects, and any other effects not mentioned herein will be clearly understood from the following description by those skilled in the art to which the present disclosure pertains.

### DESCRIPTION OF THE DRAWINGS

The above and other aspects and features of certain embodiments of the present disclosure will be more apparent from the following description taken in conjunction with the accompanying drawings, in which:

FIG. 1 is a schematic diagram of a glass-ceramic according to an embodiment of the present disclosure.

FIG. 2 is a flowchart of a method of manufacturing a glass-ceramic according to an embodiment of the present disclosure.

FIG. 3 is a schematic diagram of a cooktop according to an embodiment of the present disclosure.

FIG. 4 is a photograph showing diffused reflection of a display layer according to an embodiment of the present disclosure.

FIG. 5 is a photograph showing diffused reflection of a display layer of Comparative Example 1.

FIG. 6 is an enlarged transmission electron microscope (TEM) image of a surface of a glass-ceramic according to an embodiment of the present disclosure.

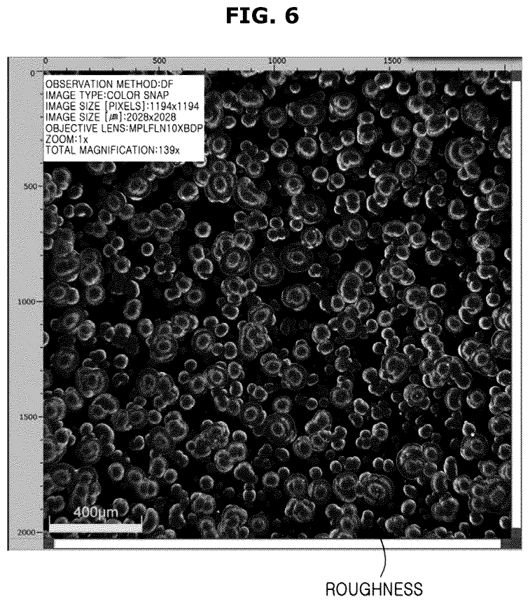

FIG. 7 is a photograph showing states of a top plate of a cooktop according to an embodiment of the present disclosure to which a Kimchi contaminant is applied before (left) and after (right) cleaning.

FIG. 8 shows photographs showing scratches with respect to loads in Comparative Example 3.

FIG. 9 shows photographs showing scratches with respect to loads in Example 2.

FIG. 10 is a photograph showing scratches of Example 2.

FIG. 11 is a photograph showing scratches of Comparative Example 3.

### DETAILED DESCRIPTION

Hereinafter, embodiments of the present disclosure will be described in detail with reference to the accompanying drawings. These embodiments are provided to fully convey the concept of the present disclosure to those of ordinary skill in the art. The present disclosure may, however, be embodied in many different forms and should not be construed as limited to the exemplary embodiments set forth herein. In the drawings, parts unrelated to the descriptions are omitted for clear description of the disclosure and sizes of elements may be exaggerated for clarity.

Throughout the specification, the term “comprising” or “including” an element specifies the presence of the stated element, but does not preclude the presence or addition of one or more elements, unless otherwise stated.

An expression used in the singular encompasses the expression of the plural, unless otherwise indicated.

A glass-ceramic 20 according to an embodiment of the present disclosure includes: a glass material 300 including an uneven layer; a coating layer 200 disposed on the glass material 300, wherein the coating layer 200 includes an upper printed layer: and a lower printed layer is disposed under the glass material 300, wherein the uneven layer has micro-dimples 100.

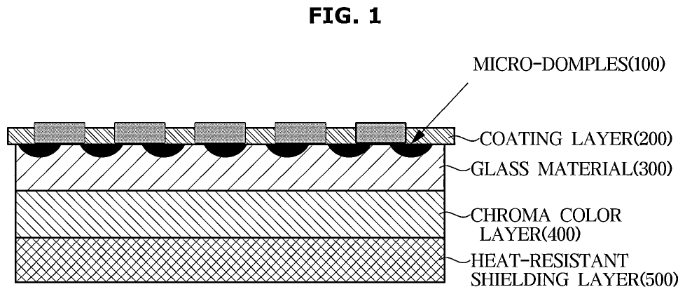

FIG. 1 is a schematic diagram of a glass-ceramic according to an embodiment of the present disclosure.

Referring to FIG. 1, the glass-ceramic according to an embodiment of the present disclosure includes the glass material 300 including an uneven layer having the micro-dimples 100, and the coating layer 200 including an upper printed layer and disposed on the glass material 300, wherein the lower printed layer may be disposed under the glass material 300.

In the glass-ceramic 20 according to an embodiment of the present disclosure, the glass material 300 may include, in wt %, 1 to 10% of Li₂O, 15 to 25% of Al₂O₃, and a remaining balance of wt % comprises SiO₂ and impurities.

Li₂O serves to increase hardness of the glass-ceramic. Therefore, in the case of using a small amount of Li₂O, it may be difficult to obtain sufficient hardness of the glass-ceramic. However, in the case of using an excess of Li₂O, manufacturing costs may be increased. Therefore, Li₂O may be contained in an amount of 1 to 10%.

Al₂O₃ serves to improve corrosion resistance and durability of the glass-ceramic. Therefore, in the case of using a small amount of Al₂O₃, corrosion resistance and durability of the glass-ceramic may deteriorate. However, in the case of using an excess of Al₂O₃, manufacturing costs may be increased. Therefore, Al₂O₃ may be contained in an amount of 15 to 25%.

SiO₂ serves as a nucleating agent in the glass-ceramic. Therefore, in the case of using a small amount of SiO₂, crystals are not sufficiently formed in the glass-ceramic and thus reflectance may deteriorate. However, in the case of using an excess of SiO₂, hardness and durability of the glass-ceramic may deteriorate. In addition, unintended impurities may inevitably be incorporated from raw materials or surrounding environments during a common manufacturing process, and thus addition of other impurities is not excluded. These impurities are known to any person skilled in the art of manufacturing and details thereof are not specifically mentioned in the present disclosure.

In the glass-ceramic 20 according to an embodiment of the present disclosure, the micro-dimples may have widths in a range from 50 μm to 150 μm and depths in a range from 20 μm to 100 μm.

The micro-dimples serve to improve cleanability and may be formed in recessed shapes. In the case of using micro-dimples having widths less than 50 μm, cleanability cannot be sufficiently improved. In the case where the widths exceed 150 μm, clarity of color may decrease. Therefore, the widths of the micro-dimples may be adjusted to the range from 50 μm to 150 μm. In addition, in the case where the depths of the micro-dimples are less than 20 μm, cleanability cannot be sufficiently improved. In the case where the depths exceed 100 μm, clarity of color may decrease. Therefore, the depths of the micro-dimples may be adjusted to the range from 20 μm to 100 μm, preferably, 30 μm to 74 μm.

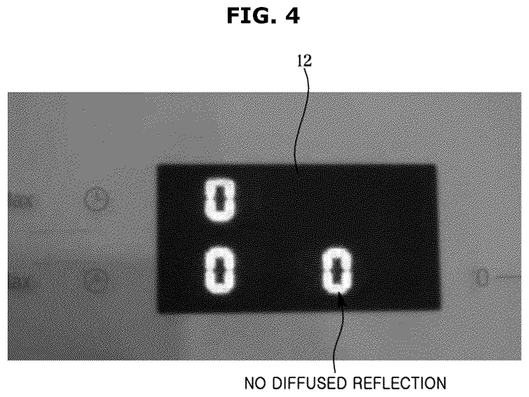

In the glass-ceramic 20 according to an embodiment of the present disclosure, the upper printed layer may include a display layer, and the display layer may have a transmittance of in a range from 80% to 90%. Referring to FIG. 4, in the case where the transmittance is in a range from 80% to 90% in the present disclosure, it may be confirmed that diffused reflection does not occur and highly transparent display visibility is obtained, and preferably, the transmittance of the display layer may be in a range from 85% to 90%.

In the glass-ceramic 20 according to an embodiment of the present disclosure, the coating layer 200 may include at least one compound selected from SiO₂, polysilazane (SiN), SiX, C₄F₉CH₃, C₆F₁₄, C₅H₃₀F₉, Zr, ZrO and ZrO₂, and antifouling property and heat resistance may be improved by forming the coating layer 200 (where X is a halogen element).

Unintended impurities may inevitably be incorporated into the coating layer 200 from raw materials or surrounding environments during a common manufacturing process, and thus addition of other impurities is not excluded. These impurities are known to any person skilled in the art of manufacturing and details thereof are not specifically mentioned in the present disclosure.

In addition, in the glass-ceramic 20 according to an embodiment of the present disclosure, the coating layer 200 may have a thickness in a range from 30 nm to 800 nm.

In the case where the thickness of the coating layer is less than 30 nm, antifouling property and heat resistance are not sufficient. In the case where the thickness of the coating layer exceeds 800 nm, clarity of color may decrease due to the too thick coating layer. Therefore, the thickness of the coating layer is controlled in a range from 30 nm to 800 nm.

In addition, in the glass-ceramic 20 according to an embodiment of the present disclosure, the lower printed layer may further include a chroma color layer 400. The present disclosure may realize various colors by the chroma color layer.

In addition, in the glass-ceramic 20 according to an embodiment of the present disclosure, the lower printed layer may further include a heat-resistant shielding layer 500.

In addition, in the glass-ceramic 20 according to an embodiment of the present disclosure, a surface roughness Ra may be in a range of 2.4 μm to 4.0 μm. According to the present disclosure, cleanability may be improved by reducing surface roughness by the polishing process.

In addition, the glass-ceramic according to an embodiment of the present disclosure may have a color difference value L of 25 or more. That is, according to the present disclosure, the glass-ceramic may have improved cleanability together with improved color and reflectance.

In addition, the glass-ceramic 20 according to an embodiment of the present disclosure the coating layer 200 includes mat have a contact angle of 100° or more after being heated at 350° C. for 24 hours. In the present disclosure, heat resistance is improved by forming the coating layer 200, and thus a contact angle of 100° or more may be obtained after heating at 350° C. for 24 hours. Even after heating for 72 hours, the coating layer 200 includes a contact angle of 70° or more, that is obtained indicating that contaminants are easily removed due to oil repellency.

In addition, in the glass-ceramic 20 according to an embodiment of the present disclosure, a surface color difference (E) between before and after oil and Kimchi aging cleaning over 1200 hours may be 1.0 or less.

In addition, in the glass-ceramic 20 according to an embodiment of the present disclosure, a vertical force causing scratches may be in a range from 15 N to 20 N.

Hereinafter, a method of manufacturing a glass-ceramic 20 according to an embodiment of the present disclosure will be described.

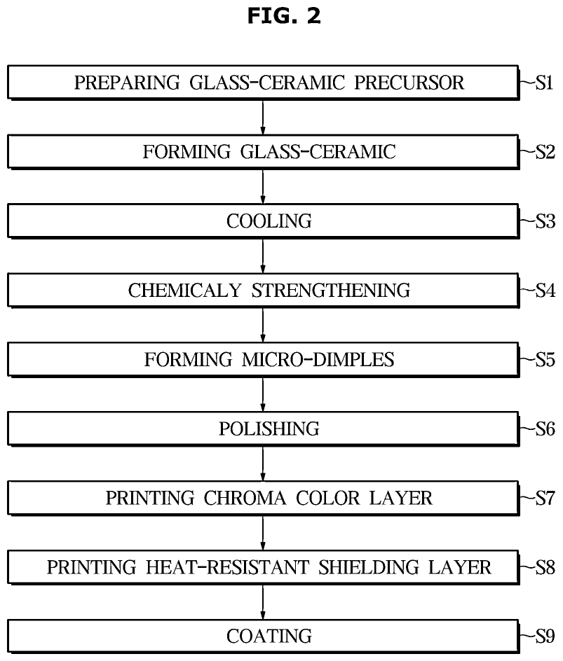

FIG. 2 is a flowchart of a method of manufacturing a glass-ceramic according to an embodiment of the present disclosure.

Referring to FIG. 2, a method of manufacturing a glass-ceramic according to an embodiment of the present disclosure includes: preparing a glass-ceramic precursor; forming a glass-ceramic via crystallization by heating: cooling the glass-ceramic: chemically strengthening the glass-ceramic: masking the glass-ceramic; forming micro-dimples: polishing: forming a lower printed layer; and coating the glass-ceramic.

Nuclei for crystallization are formed in the glass-ceramic by first heat treatment, and crystallization proceeds by growing the nuclei by second heat treatment.

A temperature of the crystallization process that is too low or a too short time for the process may cause insufficient formation of crystals, resulting in deterioration of clarity of colors and reflectance. However, a temperature of the crystallization process that is too high or a too long time for the process may cause a decrease in productivity. Therefore, it is desirable to set appropriate levels of the temperature and time for the crystallization process.

The cooling may be performed by cooling to room temperature at a cooling rate of 20° C./min or more.

In general, as a crystallization time increases and a cooling time decreases, clarity of colors of the glass-ceramic is improved, but cleanability deteriorates due to many irregularities formed on the surface of the glass-ceramic. Therefore, in general, the cooling process is not performed for a short time.

However, in the method of manufacturing a glass-ceramic according to an embodiment of the present disclosure, by performing the cooling process at a high cooling rate of 20° C./min or more, the cooling time may be reduced so that clarity of colors may be improved and cleanability may also be improved by the polishing process.

The chemically strengthening process may be performed at a temperature of 350 to 450° C. for 1 to 4 hours using a KNO₃ solution having a concentration of 90 to 100 wt% as a strengthening salt.

In the polishing process, the surface of the glass-ceramic may be polished after applying an abrasive material to a polishing ped (Softbuff). By performing the polishing process, the surface of the glass-ceramic may be more smoothed to maximize cleanability.

The masking process is performed by masking a display at a Lami speed of 2 to 4 m/min, with a Lami tension of 10 to 20%, at an atmospheric pressure in a range from 0.6 to 0.8 MPa.

The forming of micro-dimples includes blasting, chemical etching, and polishing processes, and surface roughness and gloss may be controlled by these processes.

Subsequently, the polished surface of the glass-ceramic is coated to form a coating layer. The coating process may be performed by applying a coating solution over the entire surface of the glass-ceramic and drying the coating solution at a temperature in a range from 600 to 800° C. for 5 to 15 minutes.

In the case where the drying temperature is too low or the drying time is too short, the coating layer may not be uniformly formed. However, in the case where the drying temperature is too high or the drying time is too long, cracks may occur on the surface of the coating layer.

Hereinafter, a cooktop according to an embodiment of the present disclosure will be described.

A cooktop according to another embodiment of the present disclosure includes: a cooktop main body: and a glass-ceramic 20 provided on the top of the cooktop main body, wherein the glass-ceramic 20 includes: a glass material 300 including an uneven layer; a coating layer 200 disposed on the glass material, wherein the coating layer 200 includes an upper printed layer: and a lower printed layer is disposed under the glass material 300, wherein the uneven layer 300 have micro-dimples 100.

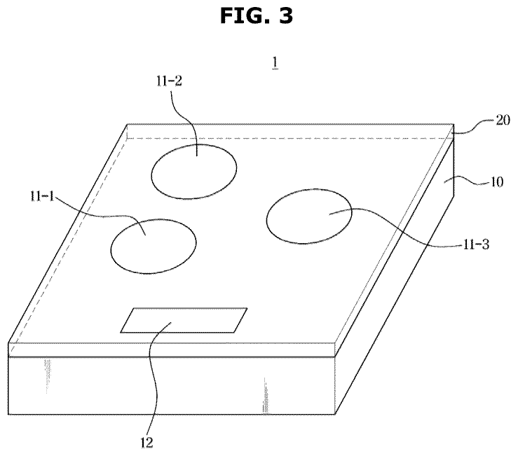

FIG. 3 is a schematic diagram of a cooktop according to an embodiment of the present disclosure.

Referring to FIG. 3, a cooktop 1 according to an embodiment of the present disclosure includes a cooktop main body 10 and a glass-ceramic 20 provided on the top of the cooktop main body 10, and the glass-ceramic 20 is as described above.

The cooktop main body 10 may include a plurality of cooking areas 11-1, 11-2 and 11-3 and a control input device 12. A plurality of heaters serving as heat sources may be embedded under the plurality of cooking areas 11-1, 11-2 and 11-3. Rims of the plurality of cooking areas 11-1, 11-2 and 11-3 may be marked to allow a user to recognize the cooking areas.

Meanwhile, although the cooktop main body 10 including three cooking areas 11-1, 11-2, and 11-3 is shown in FIG. 3, the embodiment is not limited thereto. Therefore, one, two, or more than four heaters of the same size or different sizes may be provided in the cooktop main body 10.

The control input device 12 is a component configured to control the overall function of the cooktop 1. The user may turn on or off each cooking area via the control input device 12 or control temperature of each cooking area. In addition, the user may confirm an operation state of the cooktop 1 via various display devices or light-emitting devices provided in the control input device 12.

The control input device 12 may be provided at an outer portion of the cooktop main body 10 for the convenience of user input. In FIG. 3, the control input device 12 is integrated into the top plate of the cooktop main body 10.

Hereinafter, the present disclosure will be described in more detail with reference to the following examples and comparative examples. However, the following examples are merely presented to exemplify the contents and effects of the present disclosure, and the scope and effects of the present disclosure are not limited thereto.

### EXAMPLES

### <Kimchi Cleanability Test>

A Kimchi cleanability test was performed by applying Pogi Bachu Kimchi (whole cabbage Kimchi) of CJ Cheil Jedang Corp. over the entire top plate of the cooktop according to an embodiment of the present disclosure, and performing a heating process by one cycle/day for 6 days. Each cycle includes heating the Kimchi at 150° C. for 30 minutes and resting for 30 minutes, and cleaning the top plate using a cooktop detergent.

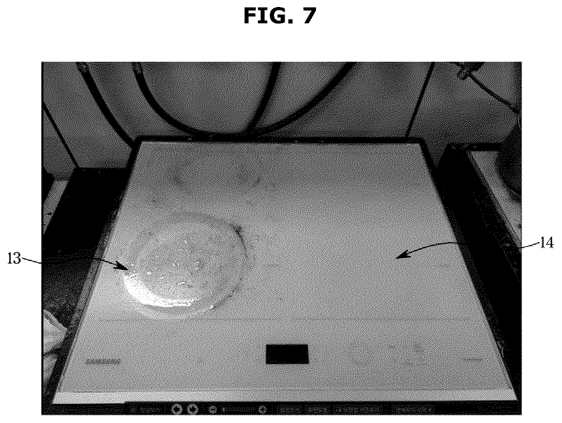

FIG. 7 is a photograph showing states of a top plate of a cooktop according to an embodiment of the present disclosure to which a Kimchi contaminant is applied before (left) 13 and after (right) 14 cleaning.

Referring to FIG. 7, it was confirmed that cleanability is improved by applying the glass-ceramic according to the present disclosure.

### <Heated Cooking Oil Cleanability Test>

A heated cooking oil cleanability test was performed by applying 3 g of a cooking oil over the entire surface of the top plate of the cooktop according to an embodiment of the present disclosure, maintaining the oil at each temperature for 30 minutes, and measuring degrees of change in surface color difference (ΔE).

Table 1 below shows surface color differences (ΔE) of the top plate of the cooktop between before and after the heated cooking oil cleanability test according to temperature. In general, a surface color difference ΔE of 1.0 or less may be determined to have good cleanability.

TABLE 1

| Temperature (° C.) | Surface Color difference |
|---|---|
| 220 | 0.07 |
| 250 | 0.16 |
| 280 | 0.59 |
| 300 | 0.08 |
| 325 | 0.14 |
| 350 | 0.73 |

Referring to Table 1, because the surface color difference (ΔE) was 1.0 or less in all temperature ranges, cleanability of heated cooking oil may be determined to be excellent. As spreadability increases, cleanability may be determined to be improved.

### <Color Difference Measurement Test>

A color difference measurement test was performed by comparing color difference values of the glass-ceramic manufactured by the method according to the present disclosure, and L*a*b* color difference was measured by using a spectrophotometer.

TABLE 2

| Color | L | Range | a | Range | b | Range |
|---|---|---|---|---|---|---|
| Black | 25.5 | ±0.5 | 0.1 | ±0.3 | −1.1 | ±0.7 |
| | 27.2 | ±0.5 | 0 | ±0.3 | −0.5 | ±0.7 |
| | 29.8 | ±0.5 | −0.1 | ±0.3 | 0.1 | ±0.7 |
| Beige | 63.9 | ±0.5 | 0.4 | ±0.3 | 3.2 | ±0.7 |
| | 64.9 | ±0.5 | 0.4 | ±0.3 | 4 | ±0.7 |
| | 71.1 | ±0.5 | −1.1 | ±0.3 | 5.4 | ±0.7 |
| Pink | 72.8 | ±0.5 | 3.4 | ±0.3 | 7.7 | ±0.7 |

That is, in the case of applying the glass-ceramic according to an embodiment of the present disclosure, a value L of 25.5 to 29.8, a value a of −0.4 to 0.4, and a value b of −1.8 to 1.8 were obtained in Examples 1 to 3 in which the color was black, a value L of 63.9 to 71.1, a value a of −1.4 to 0.7, and a value b of 2.5 to 6.1 were obtained in Examples 4 to 6 in which the color was beige, and a value L of 72.3 to 73.3, a value a of 3.1 to 3.7, and a value b of 7.0 to 8.4 were obtained in Example 7 in which the color was pink.

### <Diffused Reflection Test According to Transmittance of Display>

TABLE 3

| | | Diffused |
|---|---|---|
| | | reflection |
| Comparative Example 1 | transparent glass, not printed | ◯ |
| Comparative Example 2 | transparent glass, smog printed | ◯ |
| Example 1 | micro-dimples (1 μm) | X |
| Example 2 | micro-dimples (3 μm) | X |
| Example 3 | micro-dimples (5 μm) | X |

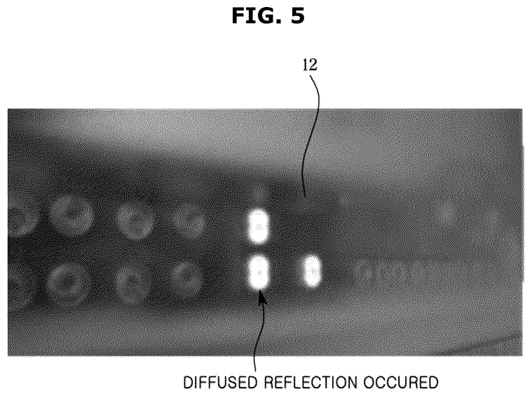

Referring to Table 3 and FIGS. 4 and 5, it was confirmed that diffused reflection did not occur in Examples 1 to 3 in which transmittance was from 80 to 90%, but diffused reflection occurred in Comparative Examples 1 and 2 in which transmittance was less than 80%.

### <Scratch Test>

A variable load scratch test was conducted by using a method including applying a vertical force to specimens via a diamond indenter (Rockwell C cone), and observing scratch behavior on surfaces of the specimens. In this regard, the vertical force applied to the specimens was constantly increased from 0.5 N to 30 N, and the scratch behavior was observed by using an optical or electron microscope while moving the specimen at a speed of 0.57 mm/s. As the vertical force causing scratches, a vertical force at a time when scratches were visually recognized was measured. The time when scratches were visually recognized was evaluated based on a time at which a luminance difference between a position where scratches occurred and the background of the glass-ceramic was 3%.

TABLE 4

| | Load | 1 kgf | 2 kgf | 3 kgf | 5 kgf | 10 kgf |
|---|---|---|---|---|---|---|
| Comparative | general black | 10 | 5 | 1 | 1 | 1 |
| Example 3 | | | | | | |
| Comparative | general black + AlSiN | 15 | 10 | 5 | 1 | 1 |
| Example 4 | coating | | | | | |
| Example 1 | micro-dimples (1 μm) | 50 | 30 | 10 | 5 | 5 |
| Example 2 | micro-dimples (3 μm) | 1000 | 100 | 100 | 100 | 100 |
| Example 3 | micro-dimples (5 μm) | 1000 | 1000 | 500 | 100 | 100 |

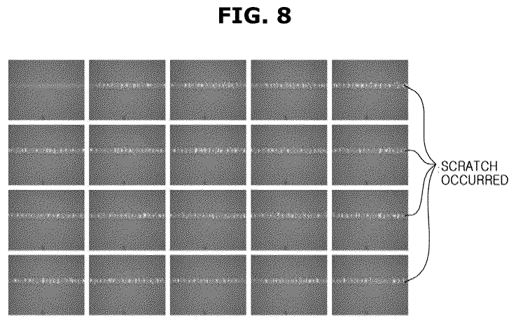

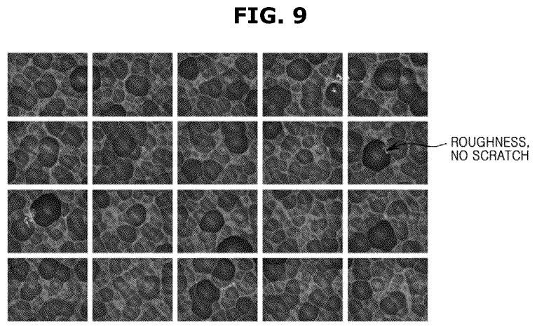

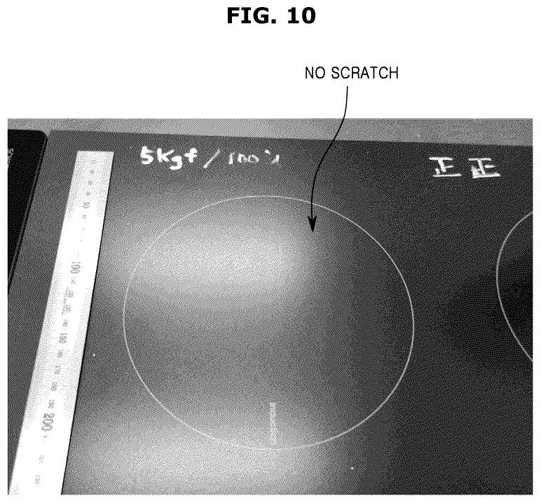

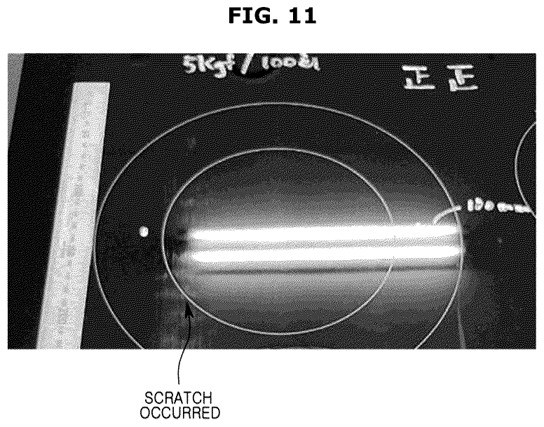

Referring to Table 4 and FIGS. 8 to 11, it was confirmed that no scratches occurred in Examples 1 to 3 even by a load applied thereto, and scratches occurred in Comparative Examples 3 and 4.

### <Heat Resistance Test>

After forming a coating layer including SiO₂/C₄F₉CH₃/C₆F₁₄, and C₅H₃₀F₉ according to an embodiment, contact angles were measured over time in a high-temperature chamber at 300° C. and shown in Table 5 below. In this regard, the contact angle refers to an average value of contact angles measured at three random points.

TABLE 5

| | Conditions for heat resistance test | | |
|---|---|---|---|
| | 350° C., 24 h | 350° C., 48 h | 350° C., 72 h |
| Contact angle after | 105° | 86° | 70° |
| heat resistance test | | | |

According to the present disclosure, it was confirmed that oil repellency was obtained after heating at 350° C. for 24 hours because the contact angle of 105° or more was maintained, and deterioration in oil repellency was inhibited even after heating 72 hours because the contact angle of 70° or more was maintained.

What is claimed is:

1. A glass-ceramic comprising:
a glass material comprising an uneven layer,
a coating layer disposed on the glass material, wherein the coating layer comprises an upper printed layer, and
a lower printed layer disposed under the glass material,
wherein the uneven layer comprises micro-dimples.

2. The glass-ceramic according to claim 1, wherein the glass material comprises, in wt %, 1 to 10% of Li₂O, 15 to 25% of Al₂O₃, and a remaining balance of wt % comprises SiO₂ and impurities.

3. The glass-ceramic according to claim 1, wherein the micro-dimples have a width in a range from 50 μm to 150 μm and a depth in a range from 20 μm to 100 μm.

4. The glass-ceramic according to claim 1, wherein the upper printed layer comprises a display layer.

5. The glass-ceramic according to claim 4, wherein the display layer has a transmittance in a range from 80% to 90%.

6. The glass-ceramic according to claim 1, wherein the coating layer comprises at least one compound selected from SiO₂, polysilazane (SiN), SiX, C₄F₉CH₃, C₆F₁₄, C₅H₃₀F₉, Zr, ZrO, and ZrO₂
wherein X is a halogen element.

7. The glass-ceramic according to claim 1, wherein the lower printed layer further comprises a chroma color layer.

8. The glass-ceramic according to claim 1, wherein the lower printed layer further comprises a heat-resistant shielding layer.

9. The glass-ceramic according to claim 1, wherein the coating layer has a thickness in a range from 30 nm to 800 nm.

10. The glass-ceramic according to claim 1, wherein a surface roughness Ra is in a range from 2.4 μm to 4.0 μm.

11. The glass-ceramic according to claim 1, wherein a color difference value L is 25 or more.

12. The glass-ceramic according to claim 1, wherein the coating layer comprises a contact angle that is 100° or more after heating at 350° C. for 24 hours.

13. The glass-ceramic according to claim 1, wherein the coating layer comprises a contact angle that is 70° or more after heating at 350° C. for 72 hours.

14. The glass-ceramic according to claim 1, wherein a surface color difference ΔE before and after cleaning oil and Kimchi aging over 1200 hours is 1.0 or less.

15. The glass-ceramic according to claim 1, wherein a vertical force causing scratches is in a range from 15 N to 20 N.

16. A cooktop comprising:
a glass-ceramic;
wherein the glass ceramic comprises:
a glass material comprising micro-dimples having at least one of widths in a range from 40 μm to 150 μm or depths in a range from 30 μm to 74 μm, so as to improve cleanability and to prevent the decrease in clarity of color;
a coating layer disposed on the glass material, wherein the coating layer comprises a display layer, the display layer having transmittance in a range from 85% to 90% for preventing diffused reflection and for having transparency; and
a lower printed layer comprising a heat-resistant shielding layer.

17. The cooktop according to claim 16, wherein the lower printed layer further comprises a chroma color layer.

18. The cooktop according to claim 16, wherein the display layer has a transmittance in a range from 80% to 90%.
